(19) United States
(12) Patent Application Publication
(10) Pub. No.: US 2024/0296756 A1
(43) Pub. Date: Sep. 5, 2024

(54) Training Device

(71) Applicant: Central Connecticut State University, New Britain, CT (US)

(72) Inventor: Edward Zrenda Moore, Woodbridge, CT (US)

(73) Assignee: Central Connecticut State University, New Britain, CT (US)

(21) Appl. No.: 18/592,971

(22) Filed: Mar. 1, 2024

Related U.S. Application Data
(60) Provisional application No. 63/449,747, filed on Mar. 3, 2023.

(51) Int. Cl. G09B 23/32; A61H 99/00

(52) U.S. Cl. CPC G09B 23/32; A61H 99/00

(57) ABSTRACT

An orthopedic training device and a method of manufacturing an orthopedic training device is provided. The training device includes at least two members each member sized and shaped to simulate a human bone structure, the at least two member defining a joint therebetween. A base is operably coupled to a first end of a first member of the at least two members. An elastic element operably coupled to the base on a second end and to a second member of the at least two members on a third end. A tensioner is operably coupled to the base and configured to selectively change a tension on the elastic element.

### CROSS-REFERENCE TO RELATED APPLICATIONS

The present application claims the benefit of, and is a non-provisional application of, U.S. Provisional Application Ser. No. 63/449,747 filed on Mar. 3, 2023 entitled “Training Device,” the contents of which are incorporated herein by reference.

### BACKGROUND OF THE INVENTION

### 1. Field of the Invention

The invention disclosed herein relates to medical training aids for skeletal manipulations, and in particular to a device for resetting dislocated digits.

### 2. Description of the Related Art

Aggressive sports play often leads to “sports related injuries.” Examples of sports related injuries include dislocation of joints such as fingers, toes, elbows, shoulders, and kneecaps. Unfortunately, the stated injuries are not limited to professional sports where there may be trained staff available to address the injury. Sports related injuries frequently occur on the athletic fields of colleges, high schools, and may even occur in middle schools.

Many sports related injuries are actually nominal and relatively benign if treated immediately. For example, dislocated joints may be reset by someone having a modest amount of training. In fact, training may amount to a modest amount of practice with suitable training devices prior to attending to a patient.

Thus, what are needed are methods and apparatus to assist training of field personnel on resetting dislocated joints. It is desired that the methods and apparatus be inexpensive and thus may be made readily available at a nominal cost. It is further desired that the methods and apparatus accommodate training of individuals with a wide range of medical skills.

### SUMMARY OF THE INVENTION

According to one aspect of the disclosure, an orthopedic training device is provided. The device includes at least two members each member sized and shaped to simulate a human bone structure, the at least two member defining a joint therebetween. A base is operably coupled to a first end of a first member of the at least two members. An elastic element operably coupled to the base on a second end and to a second member of the at least two members on a third end. A tensioner is operably coupled to the base and configured to selectively cphange a tension on the elastic element.

According to another aspect of the disclosure, a orthopedic training device is provided. The device includes a hand structure member having a plurality of digits and a palm area, the hand structure being sized and shaped to simulate a human hand. At least two members are disposed in one of the plurality of digits, each member of the at least two members being sized and shaped to simulate a human bone structure, the at least two member defining a joint therebetween. A base is disposed at least partially in the palm area and operably coupled to a first end of a first member of the at least two members. An elastic element is operably coupled to the base on a second end and to a second member of the at least two members on a third end. A tensioner is operably coupled to the base and configured to selectively change a tension on the elastic element.

According to yet another aspect of the disclosure, a method of manufacturing an orthopedic training device is provided. The method includes coupling a first member to a base, the first member being sized and shaped to simulate a first human bone structure. At least one elastic member is placed in a first thruway that extends from a base end of the first member to an opposing end of the first member. A second member is aligned with the first member, the first member being sized and shaped to simulate a first human bone structure. The second member is coupled to the first member with the at least one elastic member.

These and other advantages and features will become more apparent from the following description taken in conjunction with the drawings.

### BRIEF DESCRIPTION OF THE DRAWINGS

The features and advantages of the invention are apparent from the following description taken in conjunction with the accompanying drawings in which:

FIG. 1 is an schematic diagram depicting an assembled training aid;

FIG. 2 is an schematic diagram depicting the training aid of FIG. 1 without tensioners;

FIG. 3 is a schematic diagram depicting a tensioner for the training aid of FIG. 1;

FIG. 4 is a perspective cutaway diagram of the assembled training aid of FIG. 1 including cables;

FIG. 5 is a side-view cutaway diagram of the assembled training aid of FIG. 1 including cables;

FIG. 6 is a perspective cutaway diagram of a simulated hand incorporating the assembled training aid of FIG. 1; and

FIG. 7 is a perspective cutaway diagram of the simulated hand of FIG. 6 including a warming device.

### DETAILED DESCRIPTION OF THE INVENTION

Disclosed herein is a training aid for training individuals on alignment of skeletal members. In the example shown, the training aid, also referred to as a “phantom” includes artificial bones that form joints therebetween. As one skilled in the art will recognize, additional elements, which are not shown may be included. For example, stopping materials such as cotton may be laid over the artificial bones and then further surrounded by elastomeric material that is similar to skin.

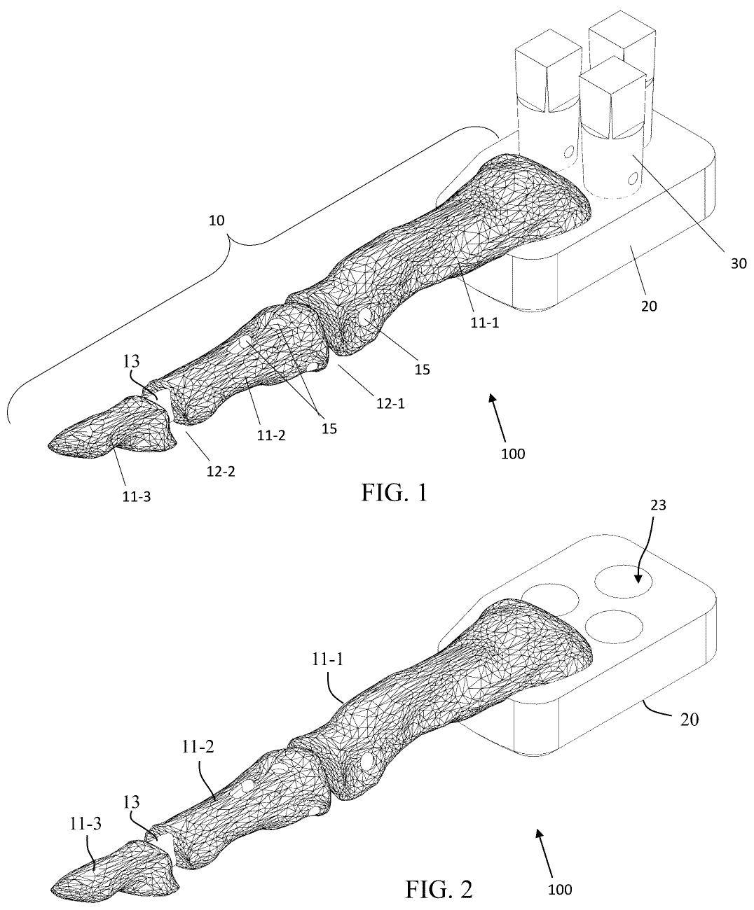

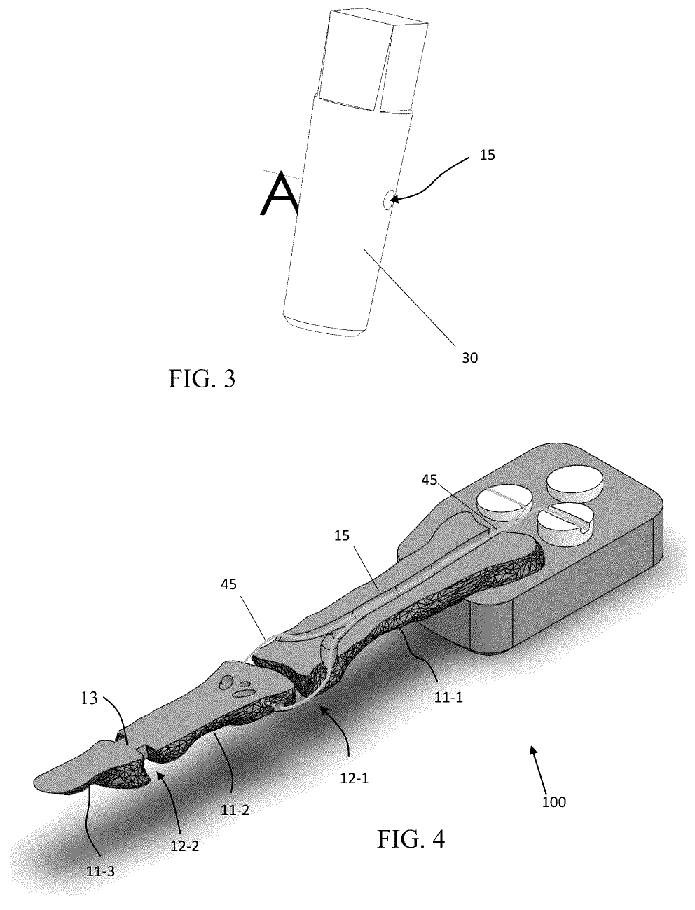

Referring to FIGS. 1 through 5, the core of a training aid or phantom 100 is shown. In this example, the phantom 100 includes a base 20 and a member 10. The base 20 provides a secure foundation for the member 10 and is host to a plurality of tensioning members 30, each of which may be disposed in a receiving area, such as openings 23 formed in the base 20.

In the example shown, the phantom 100 mimics the bone structure of an index finger. It should be appreciated that while embodiments herein refer to the phantom 100 as being an index finger, this is for example purposes and the claims should not be so limited. In other embodiments, the phantom 100 may be configured to simulate the bone structure for any other finger of the hand without deviating from the teachings provided herein. A first section of the index finger 11-1 (e.g. simulating a proximal phalanx) is anchored to the base 20. A second section of the index finger 11-2 (e.g. simulating a middle phalanx) is separated from the first section of the index finger 11-1 by a first joint 12-1. The second section of the index finger 11-2 is separated from the third section of the index finger 11-3 (e.g. simulating a distal phalanx) by a second joint 12-2. In this example, the second joint 12-2 includes a member 13 between the second section of the index finger 11-2 and the third section of the index finger 11-3, thereby fixing the second and third section to each other.

The first section of the index finger 11-1 and the second section of the index finger 11-2 include various thruways 15. The thruways 15 may be strategically located throughout the member 10. In an embodiment, the thruways 15 are disposed internally within one or more of the index finger 11-1, index finger 11-2, or index finger 11-3. Generally, thruways 15 provide channels for at least one elastic element 45. The at least one elastic element 45 is woven appropriately through thruways 15 and from member attend to base 20. The at least one elastic element 45 is then woven into at least one thruway 15 located in at least one tensioning member 30. In the example shown, the tensioning member 30 is substantially frusto-conical or peg like. Elastic element 45 is passed through thruway 15 and secured. Elastic element 45 may be secured by way of a knot too large to pass back through thruway 15. It should be appreciated that the elastic element 45 may also be secured by other means, such as but not limited to adhesive, clips, or threaded fasteners for example.

In the illustrated embodiment, the thruway 15 of index finger 11-1 bifurcates at an end distal from the base 20. This allows a pair or elastic elements 45 to pass through the index finger 11-1 and exit separate openings. In this embodiment, the thruway 15 of index finger 11-1 includes a first opening on an end adjacent the base 20 and a second opening and third opening on a side of the index finger 11-1 near an opposing opposite end. In this embodiment, the index finger 11-2 may further include a thruway that extends from one side (e.g. the bottom side) of the index finger 11-2 to an opposite side (e.g. the top side). In an embodiment, the elastic element 45 is routed through the thruway 15 of index finger 11-2, out at least one of the second opening or third opening, extends across the joint 12-1 and through the thruway 15 of index finger 11-2. In an embodiment, the elastic member 45 is secured by tying a knot 17 where the elastic member exits the thruway 15 of index finger 11-2.

It should be appreciated that while embodiments herein use an elastic member 45 to simulate the forces generated by an actual ligament, in other embodiments different mechanisms may be used. For example, an elastic force may be provided by using magnets, a spring or guided tracks (or a combination of these and/or other components) at the joint being simulated. When using a magnetic arrangement, one side of the joint 12-1 is at least partially formed of a magnetic material (e.g. magnetite or lodestone) while an opposite side of the joint 12-1 is at least partially formed of a ferromagnetic material (e.g. steel). By configuring the magnetic material a desired level of resistance may be achieved during the reduction of the joint. In a guided track arrangement, a projection on side of the joint 12-1 engages a slot on the opposite side of the joint 12-1. The slot is shaped to place the index finger 11-2 in a location where a dislocated bone would be found in an actual patient. The friction between the slot and the projection as the dislocated index finger 12-2 is moved provides resistance to simulate the forces that the user would experience on a real patient. In an embodiment, the elastic member 45 simulates a realistic magnitude of the peak force in relocating the displaced bones and also the change in force as the reduction occurs. It should be appreciated that the elastic member 45 provides additional advantages in allowing for variation in the forces the user experiences during training.

The physical appearance of the member 10 generally mimics the bone structure of a potential patient. Fabrication of the member 10 may occur through any of a number of known techniques such as by casting, modeling, digital imaging, laser printing, carving, molding, and the like. Materials for the member 10 may include a wide variety of polymers, plastics and/or natural materials. In an embodiment, the member 10 may be made from but is not limited to polyurethane foam, hydroxyapatite, silicate glasses (bioglass), glass ceramics, or calcium phosphates for example. In still further embodiments, the member 10 may be printed from a metallic (titanium alloy) or polymers using an additive manufacturing technique. The elastic element 45 may include any of a variety of suitable materials, including, for example, commercially available elastomer, rubber, elastic bands, rubber tubing, elements of bungee cords and the like. In some embodiments a polyamide, such as Nylon® monofilament fishing line is used. In some of these embodiments, the monofilament line is thirty pound (13.6 kg) test strength, but other strengths may be used. In some embodiments, the elastic element 45 may be made from a combination of the foregoing materials.

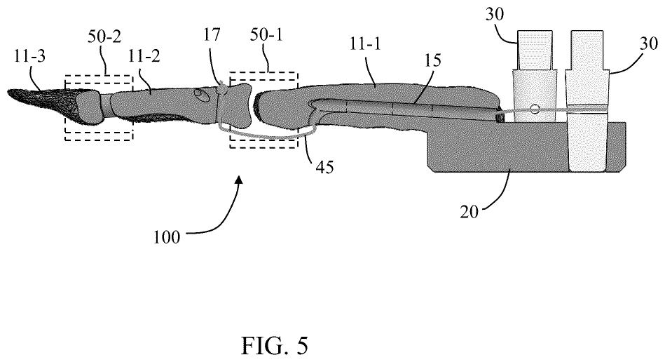

In an embodiment, an optional elastic tube 50-1 and optional elastic tube 50-2 (FIG. 5) may be placed over and between the joints 12-1, 12-2 respectively. The elastic tubes 50-1, 50-2 provide resistance to dislocation equivalent to a real joint. In an embodiment, the elastic tubes 50-1, 50-2 may be made from a polymer tubing, such as medical tubing for example.

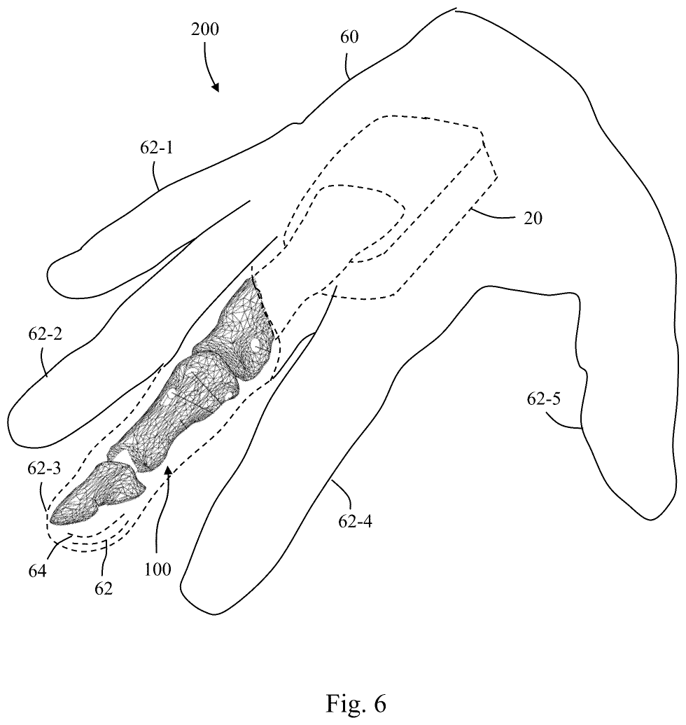

Referring now to FIG. 6, with continuing reference to FIGS. 1-5, an embodiment is shown of a training device 200. In this embodiment, the phantom 100 is embedded in a simulated hand structure 60 with the base 20 being positioned in the palm area of the simulated hand structure 60. In the illustrated embodiment, the phantom 100 is disposed in the finger 62-3. In an embodiment, the simulated hand structure 60 may be configured to allow phantom 100 to be placed in any of the fingers 62-1, 62-2, 62-3, 62-4, 62-5. The simulated hand structure 60 may be comprised of a plurality of layers 64, 66 to provide a desired level realism when being used by student. The layers can include a thin sleeve 64 of soft material (e.g. cotton) which simulates the fascia and other soft tissue. A second layer may include a thin flexible sleeve 66, such as an elastomeric material for example, which acts as skin. It should be appreciated that having a training device 200 provides additional advantages in providing simulated treatment for the student in giving them experience in not just the injured digit, but also having to manage the other portions (e.g. fingers) of the patient while the corrective procedure is being applied.

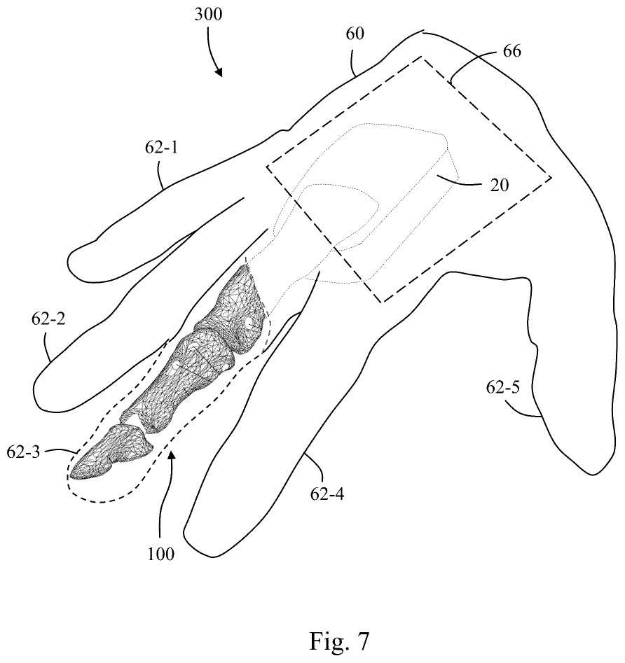

Referring now to FIG. 7, which continuing reference to FIGS. 1-5, an embodiment is shown of a training device 300. The training device 300 is similar to the training device 200 in that a simulated hand structure 60 is provided that receives the phantom 100. In this embodiment, the simulated hand structure 60 is configured to receive a heating device 66. The heating device 66 may be positioned in the palm area of the simulated hand structure 60, adjacent to the base 20. In an embodiment, the heating device 66 is an air-activated heating device that generates an exo-thermic reaction. The air-activates heating device may include an air permeable pouch that includes cellulose, iron, activated carbon, vermiculite and salt. The mixture produces an exothermic oxidation of the iron when exposed to air. It should be appreciated that the heating device will warm the simulated hand structure 60 to provide advantages in having increased realism to the simulation when the student is being trained. In another embodiment, the heating device 66 may include a resistive element powered by a power supply, such as a battery.

Having introduced the phantom 100, additional aspects and other considerations are now presented.

The medical phantom is an orthopedic training aid which allows students to practice reduction of dislocated joints such as fingers, toes, elbows, shoulders, and kneecaps, with realistic force and motion requirements. Critical ligaments are simulated using materials with material properties and attachment points comparable to that of live patients. Ligament tension is adjustable, which allows instructors to counteract creep and permanent strain of the ligaments due to repeated dislocation and reduction of the training aid, as well as simulate variability of patient ligament stability.

It is desired for students of athletic training, emergency medicine, orthopedic medicine, emergency medical technicians, physical therapy, veterinary medicine, nurse practitioners, or sports medicine to learn these maneuvers. In just the United States, there are hundreds of schools offering each degree, and the students would benefit from practicing on each type of joint that is commonly dislocated (fingers, knees, and shoulders are the most common).

There are commercially available static models of each joint, and some educators have disassembled them and modified them to allow students to experience some aspects of a real joint relocation, but nothing in the literature or the commercial market simulates both the force required and the motion as well as this device does.

Live patients are treated as training opportunities for students, whether in the emergency room or on the sidelines of a college sporting event. They wait for an injury, and then, under supervision, perform the reduction procedure on the unfortunate patient for the first time. It is possible that they will never encounter a particular joint dislocation in school, and so will be unprepared to act when they are responsible for patient wellbeing.

This device will increase expertise and confidence of medical professionals when called upon to perform a joint reduction. This should result in reduced pain and experienced by patients and reduce the risk of further injury to the joint.

By providing a tensioning device such as a friction peg (like a tuning peg used in a violin or harp pedbox), hollow set screw (such as in wire deck railing), worm gear with a drum (found on electric guitar tuners), cam lock etc. users may set the tension to the correct level after each relocation practice. Furthermore, the tension system is configured to allow easy replacement of the ligament phantom should it fracture, unlike most medical models, which are difficult or impossible to repair. This will add value for the users. Motors may be used as well, and in some embodiments tension may be monitored and adjusted through use of a suitable controller. Memory shape alloys may also be used to generate tension.

Generally, the device includes two or more artificial bones that between them form the joint of interest, an elastic tube (represents joint capsule), cotton batting or other soft sheet (represents misc. soft tissue) and a thin covering of elastic material over the entire assembly (skin), plus string/cables and tensioning devices for each ligament that needs to be simulated. The bones and tensioning device for a finger joint are shown in FIG. 1. Note that two of the bones 11-2, 11-3 at joint 12-2 are coupled by a member 13 or permanently bonded, as the joint between them is not the focus of this device. It should be appreciated that in other embodiments, the joint 12-2 may be configured in the same manner as joint 12-1 without deviating from the teachings herein.

As shown in FIGS. 1-5, the tensioning devices are located away from the joint because they are large or bulky. In embodiments involving joints with larger bones (e.g. a shoulder), the tensioning devices may be located closer to the joint. It should be appreciated that in some embodiments, the tensioning device may also be located closer to the joints of a simulated hand by reconfiguring the tensioning device. Rather than bonding the ligaments to the bones as in real joints, the cables are secured (e.g. knotted) at one end and attached to the tensioning device at the other. In between, the cables pass through both bones and across the joint between them as is shown in the cross-section views of FIG. 4. In FIG. 5 the knot 17 that ends the ligament can be seen in the middle phalanx bone 11-2. It should be appreciated that while embodiments herein, illustrate and describe the training device with respect to the phalanxes bones, this is for example purposes and the training device may be used for training on the resetting of joints involving other bones of the human or an animal body, such as the joint between the phalanxes and the metacarpus, the elbow, shoulder, knee, or toes for example.

These ligaments together largely determine the allowable range of motion of this joint, and so are desired to creating a phantom that provides the desired motion for the student. The elastic members 45 are selected so that due to their cross sectional area, mechanical properties, and length, such that during operation the elastic members 45 will substantially match the force/deflection response of real patients ligaments.

Joints are surrounded by joint capsules with are stretched during a dislocation. The device uses a strong elastic tube 50-1 to cover the joint 12-1 and provide resistance to dislocation equivalent to a real joint.

The device 100, 200, 300 may be covered in a thin sleeve of soft material which simulates fascia and other soft tissue (FIG. 6, FIG. 7). Finally, the device is covered in a very thin and flexible sleeve, which acts as skin.

In use, a trainer/user may adjust the tensioners to a predetermined level and then simply mis-align the skeletal elements. The trainee/student is then given the task of realigning the elements while reducing or minimizing perturbations to the structure. In this manner, the trainee will learn the proper techniques and “feel” of the process needed for resetting a dislocation. In an embodiment, the shape of the simulated bones 11-1, 11-2 at joint 12-1 make a popping sound when the trainee realigns the simulated bones to add an additional level of realism to the simulation.

The device may be configured and constructed for any joint deemed appropriate. This includes fingers, toes, elbows, shoulders, knees and others.

All statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Various other components may be included and called upon for providing for aspects of the teachings herein. For example, additional materials, combinations of materials and/or omission of materials may be used to provide for added embodiments that are within the scope of the teachings herein. Adequacy of any particular element for practice of the teachings herein is to be judged from the perspective of a designer, manufacturer, seller, user, system operator or other similarly interested party, and such limitations are to be perceived according to the standards of the interested party.

In the disclosure hereof any element expressed as a means for performing a specified function is intended to encompass any way of performing that function including, for example, a) a combination of circuit elements and associated hardware which perform that function or b) software in any form, including, therefore, firmware, microcode or the like as set forth herein, combined with appropriate circuitry for executing that software to perform the function. Applicants thus regard any means which can provide those functionalities as equivalent to those shown herein. No functional language used in claims appended herein is to be construed as invoking 35 U.S.C. § 112 (f) interpretations as “means-plus-function” language unless specifically expressed as such by use of the words “means for” or “steps for” within the respective claim.

When introducing elements of the present invention or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements. The term “exemplary” is not intended to be construed as a superlative example but merely one of many possible examples.

What is claimed is:

1. An orthopedic training device comprising:
at least two members each member sized and shaped to simulate a human bone structure, the at least two member defining a joint therebetween;
a base operably coupled to a first end of a first member of the at least two members;
an elastic element operably coupled to the base on a second end and to a second member of the at least two members on a third end; and
a tensioner operably coupled to the base and configured to selectively change a tension on the elastic element.

2. The orthopedic training device of claim 1, wherein:
the first member includes a first thruway with a first opening at the first end and at least one second opening adjacent an opposing fourth end of the first member; and
the elastic element is at least partially disposed within the first thruway.

3. The orthopedic training device of claim 2, wherein the tensioner includes a frustoconical shaped peg that is rotatably coupled to the base.

4. The orthopedic training device of claim 3, wherein the peg is configured to adjust the tension in the elastic element in response to rotating the peg.

5. The orthopedic training device of claim 1, wherein the elastic element is made from at least one of an elastomeric material, a rubber material, or a polyamide material.

6. The orthopedic training device of claim 1, wherein the at least two members are made from a material selected from the group comprising: polyurethane foam, hydroxyapatite, silicate glasses, bioglass, glass ceramics, calcium phosphates, and titanium alloy.

7. The orthopedic training device of claim 1, wherein the first member is sized and shaped to simulate a human proximal phalanx bone and the second member is sized and shaped to simulate a human middle phalanx.

8. The orthopedic training device of claim 1, further comprising a heating device thermally coupled to the at least two members.

9. The orthopedic training device of claim 1, further comprising an elastic tube coupled between the first member and the second member across the joint.

10. An orthopedic training device comprising:
a hand structure member having a plurality of digits and a palm area, the hand structure being sized and shaped to simulate a human hand;
at least two members disposed in one of the plurality of digits, each member of the at least two members being sized and shaped to simulate a human bone structure, the at least two member defining a joint therebetween;
a base disposed at least partially in the palm area and operably coupled to a first end of a first member of the at least two members;
an elastic element operably coupled to the base on a second end and to a second member of the at least two members on a third end; and
a tensioner operably coupled to the base and configured to selectively change a tension on the elastic element.

11. The orthopedic training device of claim 10, wherein the elastic element is made from at least one of an elastomeric material, a rubber material, or a polyamide material.

12. The orthopedic training device of claim 10, wherein the at least two members are made from a material selected from the group comprising: polyurethane foam, hydroxyapatite, silicate glasses (bioglass), glass ceramics, calcium phosphates, and titanium alloy.

13. The orthopedic training device of claim 10, wherein the first member is sized and shaped to simulate a human proximal phalanx bone and the second member is sized and shaped to simulate a human middle phalanx.

14. The orthopedic training device of claim 10, further comprising a heating device disposed at least partially in the palm area and thermally coupled to the at least two members.

15. The orthopedic training device of claim 10, further comprising an elastic tube coupled between the first member and the second member across the joint.

16. The orthopedic training device of claim 10, wherein the hand structure member includes a first layer and a second layer.

17. The orthopedic training device of claim 16, wherein the first layer is made at least partially from cotton and the second layer is made at least partially from an elastomeric material.

18. A method of manufacturing an orthopedic training device, the method comprising:
coupling a first member to a base, the first member being sized and shaped to simulate a first human bone structure;
placing at least one elastic member in a first thruway that extends from a base end of the first member to an opposing end of the first member;
aligning a second member with the first member, the first member being sized and shaped to simulate a first human bone structure;
coupling the second member to the first member with the at least one elastic member.

19. The method of manufacturing of claim 18, wherein the coupling of the first member to the second member includes placing a first portion of the at least one elastic member in a second thruway in the second member.

20. The method of manufacturing of claim 19, further comprising:
coupling a second portion of at least one elastic member to a tensioning member; and
actuating the tensioning member to generate a predetermined amount of tension on the at least one elastic member.
